(19) United States
(12) Patent Application Publication
(10) Pub. No.: US 2007/0225049 A1
(43) Pub. Date: Sep. 27, 2007

(54) Voice controlled push to talk system

(76) Inventor: Mauricio P. Andrada, Piscataway, NJ (US)

Correspondence Address: MOTOROLA INC, 600 NORTH US HIGHWAY 45, ROOM AS437, LIBERTYVILLE, IL, 60048-5343, US

(21) Appl. No.: 11/387,477

(22) Filed: Mar. 23, 2006

(51) Int. Cl. H04M 1/00

(52) U.S. Cl. 455/569.1; 455/90.2

(57) ABSTRACT

A method and system for establishing a voice actuated Push to Talk call are provided. The method may be employed in conjunction with, for example, a wireless, hands-free communication device (100) like a wireless headset for a mobile telephone, and a wireless, two-way communication device (101) having both a voice recognition module (110) and a push to talk mode. A user (203) is able to actuate the voice recognition module (110) by pressing a control button (107) on the wireless, hands-free communication device (100), thereby causing the wireless, hands-free communication device (100) to transmit an actuate voice recognition module command to the wireless, two-way communication device (101). The user (203) then establishes the Push to Talk session by uttering a Push to Talk command that includes a Push to Talk code word. The wireless, hands-free communication device (100) then transmits an electronic signal representation of this command to the wireless, two-way communication device (101), which through voice recognition, causes an initiate Push to Talk session command to be sent to a service provider, server or network. Similarly, the user (203) may terminate the Push to Talk session and make floor requests with corresponding audible commands.

### BACKGROUND

1. Technical Field

This invention relates generally to a system and method for providing a Push to Talk feature for a wireless communication system, and more specifically to a voice controlled Push to Talk System with which a user may establish a Push to Talk channel using voice commands.

2. Background Art

Mobile telephones, once a luxury for only the wealthy, now seem to be everywhere. From the office to the gym to restaurants to busses and trains, it seems like everyone carries a mobile telephone to stay in touch with friends, family and co-workers. While most mobile telephones work just like conventional telephones, allowing full duplex communications where both parties may talk and listen simultaneously, some have additional features. Some mobile telephone systems, for example, offer expedited, direct half-duplex communication capabilities where only one party may talk at a time.

One example of such an arrangement is the “Push to Talk” function available on some mobile phone systems. Operating much the same way that a two-way radio or walkie-talkie does, the Push to Talk function allows one party to quickly and directly poll another party's mobile telephone through a dedicated channel. Originally offered through Motorola's Integrated Digital Enhanced Network (iDEN™) and Nextel Communication's Direct Connect™ service, the Push to Talk functionality has now been extended to other networks, including Code Division Multiple Access (CDMA) networks and Global System for Mobile communications (GSM) networks.

When using a Push to Talk feature on a mobile telephone, a user first selects a recipient from a directory, then presses a Push to Talk button on the mobile telephone. The mobile device then instantly transmits a request through the network to the recipient's device. Provided the recipient is within the operable service area, their mobile telephone will hear the sender's voice without the dial, ring, and answer delay associated with the normal mobile telephone calling process.

The problem with conventional Push to Talk systems is that when using the Push to Talk function, a user must continuously hold down the Push to Talk button while speaking. The user must then release the Push to Talk button to receive messages from others. Consequently, the Push to Talk button controls the Push to Talk function, requiring a user to handle and manipulate the mobile device to take advantage of this feature.

Many states are now contemplating regulations prohibiting the use of mobile telephones in vehicles without the use of hands free accessories. Further, many occupations require both hands in their execution, thereby prohibiting the use of the Push to Talk function. While some wired headsets do facilitate Push to Talk functionality by including a hard-wired Push to Talk button, such a button still requires at least one free hand of a user to be used.

There is thus a need for an improved system and method for establishing Push to Talk communication sessions that does not require the constant manipulation of a Push to Talk button.

### BRIEF DESCRIPTION OF THE DRAWINGS

FIG. 1 illustrates a cut-away headset and cut-away mobile device for facilitating voice activated Push to Talk capabilities in accordance with the invention.

FIG. 2 illustrates one exemplary embodiment of a headset in accordance with the invention transmitting a voice actuation command to a mobile device in accordance with the invention.

FIG. 3 illustrates one exemplary embodiment of a user placing a voice activated Push to Talk call in accordance with the invention.

FIG. 4 illustrates one exemplary embodiment of a headset in accordance with the invention transmitting a Push to Talk command in accordance with the invention.

FIG. 5 illustrates one exemplary embodiment of a user placing a floor request command in accordance with the invention.

FIG. 6 illustrates an alternate exemplary embodiment of a user placing a floor request command in accordance with the invention.

FIG. 7 illustrates a block diagram of a headset and mobile device in accordance with the invention.

FIG. 8 illustrates one method for establishing a voice activated Push to Talk communication in accordance with the invention.

FIG. 9 illustrates one method for establishing a voice activated Push to Talk communication in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. Also, reference designators shown herein in parenthesis indicate components shown in a figure other than the one in discussion. For example, talking about a device (10) while discussing figure A would refer to an element, 10, shown in figure other than figure A.

### DETAILED DESCRIPTION OF THE INVENTION

Before describing in detail embodiments that are in accordance with the present invention, it should be observed that the embodiments reside primarily in combinations of method steps and apparatus components related to placing voice activated Push to Talk communications. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of establishing voice activated Push to Talk communication sessions as described herein. The non-processor circuits may include, but are not limited to, a radio receiver, a radio transmitter, signal drivers, clock circuits, power source circuits, and user input devices. As such, these functions may be interpreted as steps of a method to perform establishment of Push to Talk communication sessions. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” In this document, relational terms such as first and second, top and bottom, and the like may be used solely to distinguish one entity or action from another entity or action without necessarily requiring or implying any actual such relationship or order between such entities or actions.

A voice activated system and method for establishing a Push to Talk communication channel is described. The system and method allow a user to initiate, terminate, and perform other operations in conjunction with a Push to Talk call without having to handle a handset. The invention allows people using wireless headsets, for example, to conduct Push to Talk communications without touching the mobile telephone. Thus, where a user wearing a wireless headset is walking down the street with something in his hands, he needn't reach into his pocket to actuate buttons on the mobile telephone to make and break Push to Talk calls.

In one embodiment employing a wireless headset, like a Bluetooth headset capable of wireless communication with a mobile telephone for instance, a user presses a multi-function button on the headset. The headset then sends an “actuate voice recognition module” command to the mobile telephone, which is equipped with voice recognition software. The voice recognition software then actuates, awaiting a voice command from the user.

The user then speaks a Push to Talk command having a unique code word embedded therein. For example, the user may say, “Push to Talk Bob Jones” or “Push to Talk 555-555-1212.” Where the user speaks a person's name, the mobile device searches for that name in a Push to Talk contact list stored within the mobile telephone, or in a phonebook stored within the mobile telephone. Where the user speaks a number, the Push to Talk call is initiated to that number. In either case, the mobile telephone transmits a request to establish the Push to Talk session upon receiving the voice command from the user.

Once the Push to Talk call is in session, the user may end the session by uttering a voice command like “end Push to Talk call.” The wireless headset would then transmit an electronic representation of this command to the mobile telephone. The voice recognition module disposed within the phone would then transmit a request to terminate the Push to Talk session. In the alternative, the user may press the multifunction or another button on the headset in accordance with a predetermined sequence of taps to end the Push to Talk call.

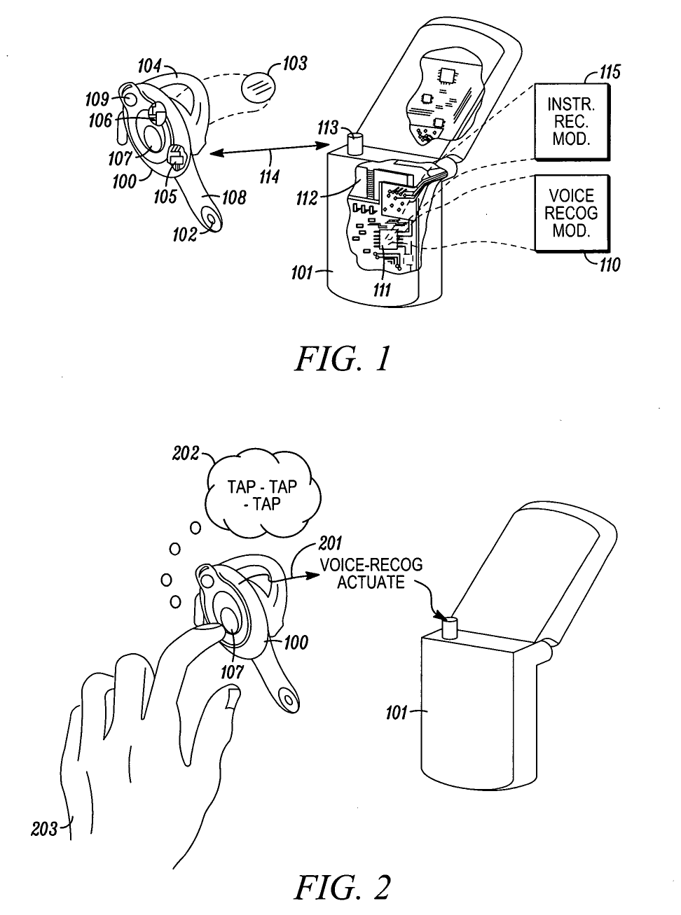

Turning now to FIG. 1, illustrated therein is a system for establishing a voice-activated Push to Talk session in accordance with the invention. The system includes a wireless, hands-free communication device 100, like a Bluetooth enabled headset for example. The wireless, hands-free communication device 100 has a control button 107 capable of actuating the various functions of the headset. The control button 107 may be a multi-function button that controls multiple operations. For example, since the wireless, hands-free communication device 100 may be suitable for wearing on an ear, designers may prefer to employ only one or a few buttons for multiple functions to keep the device small. As such, the control button 107 may work to both answer and hang-up incoming calls, for example, depending upon the current state of the wireless, hands-free communication device 100.

The wireless, hands-free communication device 100 includes a wireless, hands-free communication device transceiver 105 capable of communicating by transmitting electronic signals, e.g. 114, to a remote electronic device. For example, the wireless, hands-free communication device transceiver 105 may be a local area, low power transmitter capable of sending electronic signals including voice and software control commands to, for example, a wireless communication device. Thus, the wireless, hands-free communication device 100 includes processing circuitry 106 associated with the control button 107 for detecting control button 107 actuation. The processing circuitry 106, which may include a microprocessor, memory, signal processing and other logic circuitry, may also be used to convert audible voice received by the microphone 102 into logic signals for transmission to a remote device.

The wireless, hands-free communication device 100 includes both a microphone 102 and a loudspeaker 103 coupled to the wireless transceiver 107. The microphone 102 and loudspeaker 103 are configured for receiving and delivering analog audio to a user. The user may mount the wireless, hands-free communication device 100 on the ear by way of a pliable ear loop 104. The microphone 102 may be mounted on an extending boom 108 so as to better receive voice data from the user. Other control buttons, e.g. 109, may be included to control other functions, including power and volume.

The system also includes a wireless, two-way communication device 101. In the illustrative embodiment of FIG. 1, the wireless, two-way communication device 101 is a mobile telephone. It will be clear to those of ordinary skill in the art having the benefit of this disclosure that the invention is not so limited. For example, the wireless, two-way communication device 101 may be a personal computer having wireless capabilities that is configured to establish Voice Over Internet Protocol (VoIP) communications.

The wireless, two-way communication device 101 includes at least a two-way communication device transceiver 113 capable of sending and receiving electronic communications, e.g. 114, with a remote electronic device. The wireless, hands-free communication device transceiver 113 may include both a transmitter and receiver or a combination transceiver, along with amplification circuitry, signal processing circuitry, and an antenna for communication. In one embodiment, the wireless, hands-free communication device transceiver 113 is capable of communication with a wireless, hands-free communication device 100 so as to transmit and receive audio information to and from a user.

The wireless, two-way communication device 101 includes a processor 112 capable of executing the software instructions required to operate the wireless, two-way communication device 101. Additionally, memory 111 may be coupled to the processor 112 for storing both data and software program instructions. In one embodiment, the memory 111 includes a voice recognition module 110 stored as a series of software commands. The voice recognition module 110 is capable of receiving electronic signal representations of audible commands and translating them into instructions for the processor 112. One example of such a voice recognition module is taught in U.S. Pat. No. 6,275,800, entitled “Voice Recognition System and Method”, assigned to Motorola, Inc., which is incorporated herein by reference.

While voice recognition software is well known in the art, the '800 patent teaches voice recognition by way of a training algorithm that uses features extracted from a user's sampled speech. By way of background, in such a system an electronic device, like a mobile telephone for example, uses one or more utterances of a word or phrase to generate data parameters for a model of that word or phrase. The parameters are then stored in a model storage memory, and are later used during the speech recognition process. The recognition system compares the features of an unknown utterance with stored model parameters to determine the best match. The best matching model is then output from the recognition system as the result.

Common speech and voice recognition models employ the hidden Markov model based recognition system for this process. Hidden Markov model recognition systems allocate frames of the utterance to states of the hidden Markov model. The frame-to-state allocation that produces the largest probability, or score, is selected as the best match.

In such a system, audio signals are received by a microphone and are converted to digital signals in an analog-to-digital converter of audio circuit. Those skilled in the art will recognize that the audio circuit may provide additional signal processing, such as filtering, amplification, and other functions. A call processor performs feature extraction on the processed digital signal representation of the analog signal output by microphone and produces a set of feature vectors representative of the user utterance. A feature vector is produced for each short time analysis window. The short time analysis window is a frame may be of a predetermined duration. The processor then uses the features for speech recognition or training.

A feature extractor generally performs signal processing on a frame of input speech, and outputs feature vectors representing each frame at the frame rate. The frame rate can generally be between 10 and 30 ms. A trainer uses the features extracted from the sampled speech of one or more utterances of a word or phrase to generate parameters for a model of that word or phrase. This model is then stored in a model storage non-volatile memory. The model size is directly dependent upon the feature vector length, such that a longer feature vector length requires a larger memory.

The models stored in memory are then used during recognition. The recognition system performs a comparison between the features of an unknown utterance and stored model parameters to determine the best match. The best matching model is then output from the recognition system as the result.

Turning now back to FIG. 1, the wireless, two-way communication device 101 also includes a Push to Talk mode. Push to Talk modes are a walkie-talkie type service offered by various service providers. A wireless, two-way communication device 101 enabled with a Push to Talk mode allows customers to instantly reach other people by eliminating the dialing and ringing associated with a normal telephone call. Such services are well known in the art and are currently being offered by Nextel, Sprint, and Cingular. A Push to Talk mode, when actuated, requests establishment of communication channels with at least one other communication device. Push to Talk calls can be made to one person or to a group of people.

The wireless, two-way communication device 101 further includes an instruction receiving module 115. The instruction receiving module 115, which may be embodied as software instructions stored in the memory 111, is configured to be responsive to the wireless, hands-free communication device transceiver 113 such that instructions and other electronic signals received from the wireless, hands-free communication device transceiver 113 may be used to control the wireless, two-way communication device 101. The action of the various components of the wireless, two-way communication device 101 to establish voice activated Push to Talk sessions will be further illustrated in the discussion of FIGS. 2-6.

Turning now to FIG. 2, illustrated therein is one step of a wireless, hands-free communication device 100 operating in conjunction with a wireless, two-way communication device 101 having a both a voice recognition module (110) and push to talk mode to establish a voice actuated Push to Talk call in accordance with the invention. In FIG. 2 a user 203 actuates a control button 107 on the wireless, hands-free communication device 100 in accordance with a predetermined sequence 202. For instance, the predetermined sequence may be three taps in short succession. Alternatively, the predetermined sequence may be holding down the button 107 for at least one second. When the control button 107 is actuated in accordance with the predetermined sequence 202, the associated processing circuitry (106) causes the wireless, hands-free communication device 100 to transmit an actuate voice recognition software command 201 to the wireless, two-way communication device 101. The actuate voice recognition software command 201 causes (by way of the instruction receiving module (115)) the voice recognition module (110) operating within the wireless, two-way communication device 101 to actuate, so as to be able to receive and interpret various voice commands. The actuate voice recognition software command 201 is useful where a voice recognition module (110) temporarily goes inactive, for example to prolong battery life. Where the voice recognition module (110) is powered on continually, the step shown in FIG. 2 may be optional.

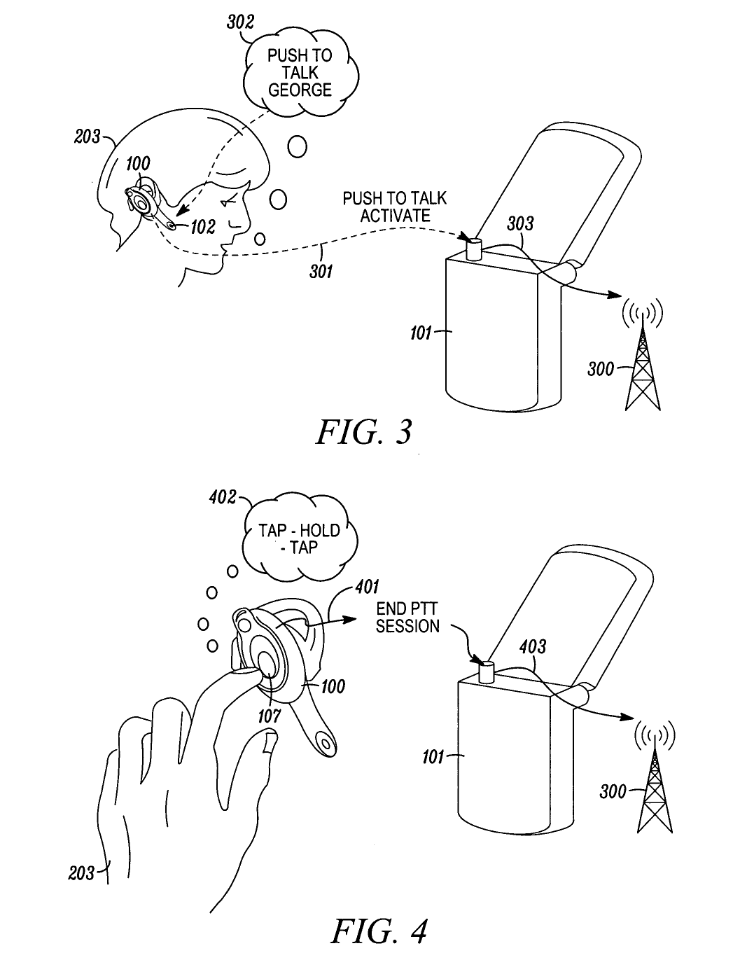

Turning now to FIG. 3, illustrated therein is one step of a wireless, hands-free communication device 100 operating in conjunction with a wireless, two-way communication device 101 having a both a voice recognition module (110) and push to talk mode to establish a voice actuated Push to Talk call in accordance with the invention. In FIG. 3, the user 203 utters an audible command 302 to establish a Push to Talk communication session. The user 203 may say, “Push to Talk 555-555-1212” or “Push to Talk George P. Burdell” as described above. This audible command 302 then becomes incident upon the microphone 102 of the wireless, hands-free communication device 100.

When the audible command 302 having a Push to Talk code word, e.g. “Push to Talk”, is incident upon the microphone 102, the wireless transceiver (105) in the wireless, hands-free communication device 100 transmits an electronic signal representation 301 of the audible command 302 to the remote electronic device 101. This command, received and interpreted by the instruction receiving module (115), causes the Push to Talk mode or module to transmit a request to establish a Push to Talk session 303. The request 303 may be sent to a service provider's server or network 300. It may include a data message, such as the person to whom the Push to Talk call initiation is directed.

Turning now to FIG. 4, illustrated therein is one step of a wireless, hands-free communication device 100 operating in conjunction with a wireless, two-way communication device 101 having a both a voice recognition module (110) and push to talk mode to end a voice actuated Push to Talk call in accordance with the invention. In FIG. 4 the user 203 actuates a control button 107 on the wireless, hands-free communication device 100 in accordance with a second predetermined sequence 202. For instance, where the first predetermined sequence (202) may have been three taps in short succession, the second predetermined sequence 402 may be tap followed by a prolonged hold, followed by another tap. When the control button 107 is actuated in accordance with the second predetermined sequence 402, the associated processing circuitry (106) causes the wireless, hands-free communication device 100 to transmit an end call software command 401 to the wireless, two-way communication device 101. The end call software command 401, received and interpreted by the instruction receiving module (115), causes the Push to Talk module of the wireless, two-way communication device 101 to transmit a request 403 to end the current Push to Talk session. The request 403 may be sent to a service provider's server or network 300, thereby terminating the Push to Talk communication channel.

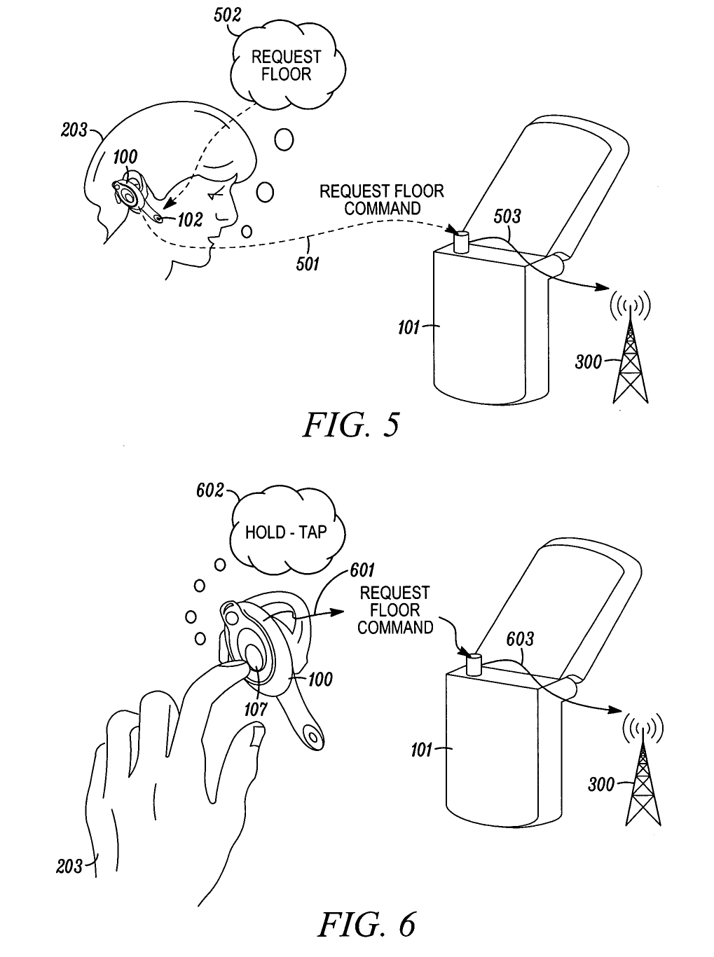

Turning now to FIG. 5, illustrated therein is one step of a wireless, hands-free communication device 100 operating in conjunction with a wireless, two-way communication device 101 having a both a voice recognition module (110) and push to talk mode to transmit a floor request during Push to Talk call in accordance with the invention. A floor request, also known as floor control, permits a certain party to speak where multiple parties are participating in a Push to Talk session. As most Push to Talk communication occurs in a “half-plex” channel, once a party has the floor during a Push to Talk session, their voice is transmitted to the other parties.

In FIG. 5, to transmit a floor request, the user 203 utters an audible command 502 including at least one floor request code word. The user 203 may say “Floor request now” or “FR Now” as examples. This audible command 502 then becomes incident upon the microphone 102 of the wireless, hands-free communication device 100. When the audible command 502 having a floor request code word is incident upon the microphone 102, the wireless transceiver (105) in the wireless, hands-free communication device 100 transmits an electronic signal representation 501 of the audible command 502 to the remote electronic device 101. This signal 501, received and interpreted by the instruction receiving module (115), causes the Push to Talk mode or module to transmit a request for the floor 503. The request 503 may be sent to a service provider's server or network 300 and may include a data message, such as the person from whom the floor request was sent.

Turning now to FIG. 6, illustrated therein is an alternate step of a wireless, hands-free communication device 100 operating in conjunction with a wireless, two-way communication device 101 having a both a voice recognition module (110) and push to talk mode to transmit a floor request in accordance with the invention. In FIG. 4 the user 203 actuates a control button 107 on the wireless, hands-free communication device 100 in accordance with a third predetermined sequence 602. For instance, where the first predetermined sequence (202) may have been three taps in short succession, and the second predetermined sequence 402 may have been a tap-hold-tap, the third predetermined sequence may be a tap followed by a hold. When the control button 107 is actuated in accordance with the third predetermined sequence 602, the associated processing circuitry (106) causes the wireless, hands-free communication device 100 to transmit a floor request software command 601 to the wireless, two-way communication device 101. The floor request software command 601, received and interpreted by the instruction receiving module (115), causes the Push to Talk module of the wireless, two-way communication device 101 to transmit a floor request 603 to the service provider's server or network 300.

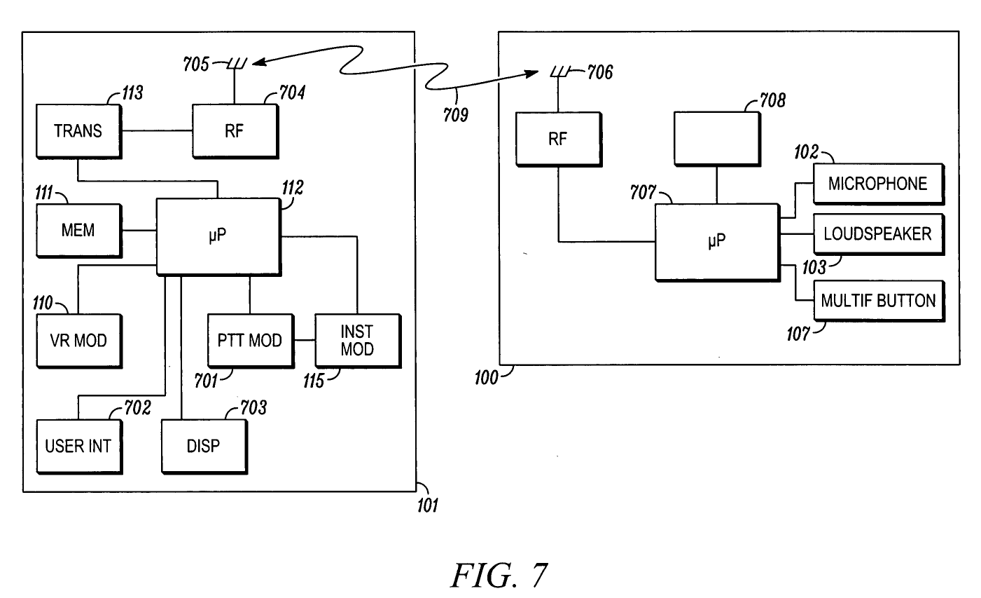

Turning now to FIG. 7, illustrated therein are block diagrams of a wireless, two-way communication device 101 and wireless, hands-free communication device 100, respectively, in accordance with the invention. As mentioned above, the wireless, two-way communication device 101 includes a processor 112 for executing software instructions and performing the various functions of the wireless, two-way communication device 101. The data and software instructions, including the voice recognition module 110, the instruction receiving module 115 and the Push to Talk module 701, may be stored as embedded software commands within the memory 111. A user interface 702, which may include a keypad, is provided for receiving instructions from a user. A display provides information from the device 101 to the user.

Wireless communication with a wireless, hands-free communication device 100 is achieved by way of the transceiver 113. The transceiver, capable of both sending and receiving electronic communications, may employ radio frequency (RF) signal processing and amplification circuitry 704 and an antenna 705 to communicate with other devices.

The wireless, hands-free communication device 100 includes similar transceiver circuitry 706 for sending and receiving messages. A processor 707 and associated memory 708 are capable of receiving information from input devices like the microphone 102, loudspeaker 103 and multifunction button 107 and transmitting electronic signal representations thereof 709 to the wireless, two-way communication device 101.

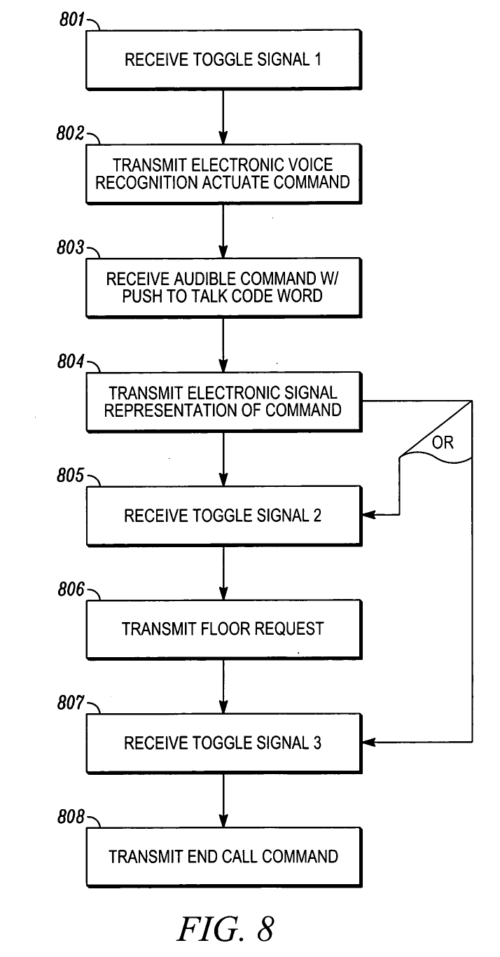

Turning now to FIG. 8, illustrated therein is one example of a method for establishing a Push to Talk communication channel in conjunction with a wireless, hands-free communication device (100) and wireless, two-way communication device (101) in accordance with the invention. The method is similar to the steps set forth in FIGS. 2-6. At step 801, a wireless, hands-free communication device (100) in accordance with the invention receives a toggle signal of a control button (107) in accordance with a first predetermined sequence. In response to receiving this toggle signal, the wireless, hands-free communication device (100) transmits an electronic actuate voice recognition software command, at step 802, to a remote device, like a wireless, two-way communication device (101) having voice recognition software disposed therein.

At step 803, the wireless, hands-free communication device (100) receives an audible command comprising at least one Push to Talk code word. This is indicative of a user desiring to initiate a Push to Talk session. In response to receiving this audible command, at step 804 the wireless, hands-free communication device (100) transmits an electronic signal representation of the audible command comprising the Push to Talk code word to the wireless, two-way communication device (101). Once the wireless, two-way communication device (101) receives the electronic signal, the Push to Talk module (701) disposed within the wireless, two-way communication device (101) will initiate the Push to Talk session accordingly.

While the Push to Talk session is on going, a user will listen and talk. The wireless, hands-free communication device (100) may receive various inputs, which cause it to take various actions. For instance, where the wireless, hands-free communication device (100) receives a toggle sequence in accordance with a predetermined floor request sequence, as illustrated at step 805, the wireless, hands-free communication device (100) transmits a floor request command to the wireless, two-way communication device (101) or remote electronic device at step 806.

In the alternative, or after receiving predetermined floor request sequence toggles 805 and transmitting floor request commands 806, the wireless, hands-free communication device (100) may receive toggle signals from the control or multifunction button (107) in accordance with a predetermined end call sequence. Such is illustrated at step 807. In response to receiving toggle sequences in accordance with such a predetermined sequence, the wireless, hands-free communication device (100) transmits an electronic end call command to the wireless, two-way communication device (101), thereby causing the wireless, two-way communication device (101) to terminate the Push to Talk communication channel.

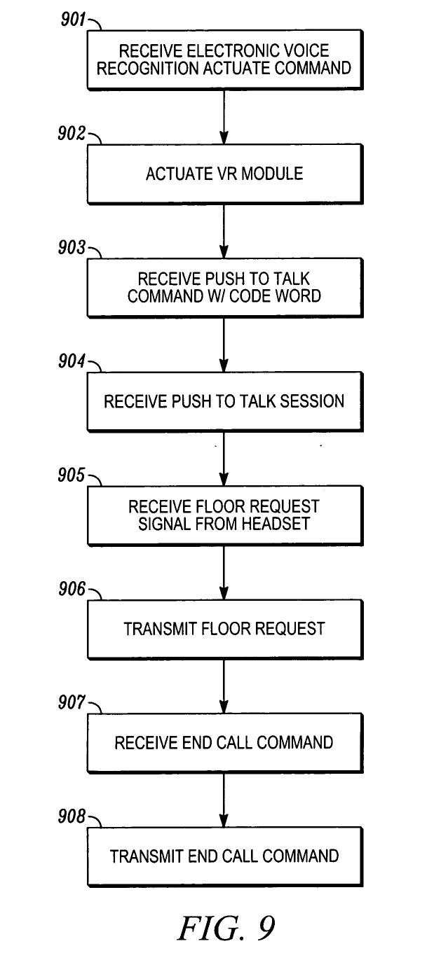

Turning now to FIG. 9, illustrated therein is a method in accordance with the invention for establishing a Push to Talk communication channel suitable for use with a wireless, two-way communication device (101) having at least a voice recognition module and a Push to Talk mode. At step 901, the wireless, two-way communication device (101) receives an electronic actuate voice recognition module command from an external source, such as a wireless, hands-free communication device (100). In response to receiving this command, at step 901, the wireless, two-way communication device (101) actuates the voice recognition module (110), thereby enabling it to receive and translate voice commands uttered by a user.

With the voice recognition module (110) enabled, the wireless, two-way communication device (101) then receives an electronic signal representation of an audible command including at least a Push to Talk code word at step 903. Upon receipt, the wireless, two-way communication device (101) requests establishment of a Push to Talk communication channel with at least one other communication device at step 904. This request serves to initiate the Push to Talk session.

Once the Push to Talk session is in progress, where for example the Push to Talk session includes multiple parties, the wireless, hands-free communication device (100) may optionally receive a toggle signal in accordance with a predetermined floor request sequence at step 905. Alternatively, the wireless, two-way communication device (101) may receive an electronic signal representation of an audible command having at least a floor request code word embedded therein at step 905. When either is received, the wireless, two-way communication device (101) transmits a floor request to a remote device, or to a network, or to a service provider at step 906.

When a user desires the Push to Talk session to end, the wireless, two-way communication device (101) may receive an electronic end call command from an external device, like a wireless, hands-free communication device (100) for instance, at step 907. In response, the wireless, two-way communication device (101) will terminate the Push to Talk communication channel.

In the foregoing specification, specific embodiments of the present invention have been described. However, one of ordinary skill in the art appreciates that various modifications and changes can be made without departing from the scope of the present invention as set forth in the claims below. Thus, while embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention.

What is claimed is:

1. A wireless hands-free communication device, comprising
a wireless transceiver capable of communicating with a remote electronic device having at least a voice recognition module and a push to talk mode; and
at least one microphone and at least one loudspeaker coupled to the wireless transceiver; and
a control button and associated processing circuitry coupled to the wireless transceiver;
wherein upon the control button being actuated in accordance with a first predetermined sequence, the associated processing circuitry causes the wireless transceiver to transmit an actuate voice recognition software command to the remote electronic device.

2. The wireless hands-free communication device of claim 1, wherein upon the control button being actuated in accordance with a second predetermined sequence, the associated processing circuitry causes the wireless transceiver to transmit an end call software command to the remote electronic device.

3. The wireless hands-free communication device of claim 1, wherein upon an audible command comprising a push to talk code word being incident upon the at least one microphone, the wireless transceiver transmits an electronic signal representation of the audible command comprising the push to talk code word to the remote electronic device.

4. The wireless hands-free communication device of claim 1, wherein upon the multi-function button being actuated in accordance with a predetermined floor request sequence, the associated processing circuitry causes the wireless transceiver to transmit a floor request command to the remote electronic device.

5. The wireless hands-free communication device of claim 1, wherein upon an audible command comprising a floor request code word being incident upon the at least one microphone, the wireless transceiver transmits an electronic signal representation of the audible command comprising the floor request code word to the remote electronic device.

6. The wireless hands-free communication device of claim 1, wherein the wireless hands-free communication device comprises a wireless headset.

7. In conjunction with a wireless hands-free communication device having at least a microphone, a loudspeaker, a wireless transceiver, and a control button, a method of using the wireless hands-free communication device comprising the steps of:
receiving a toggle signal in accordance with a first predetermined sequence from the control button; and
transmitting an electronic actuate voice recognition software command to a remote electronic device.

8. The method of claim 7, further comprising the steps of:
receiving an audible command comprising a push to talk code word; and
transmitting an electronic signal representation of the audible command comprising the push to talk code word to the remote electronic device.

9. The method of claim 8, further comprising the steps of:
receiving a toggle signal in accordance with a second predetermined sequence from the control button; and
transmitting an electronic end call command to the remote electronic device.

10. The method of claim 8, further comprising the steps of
receiving a toggle signal in accordance with a predetermined floor request sequence from the control button; and
transmitting a floor request command to the remote electronic device.

11. A wireless, two-way communication device, comprising:
a voice recognition module;
a wireless transceiver capable of communication with at least a wireless hands-free communication device having a loudspeaker, microphone and control button associated therewith;
a push to talk module, wherein when the push to talk module is actuated, a communication channel with at least one other communication device is requested; and
an instruction receiving module responsive to the wireless transceiver;
wherein when an actuate voice recognition module command and is received by the wireless transceiver, the instruction receiving module actuates the voice recognition module;
further wherein when an electronic signal representation of an audible command comprising a push to talk code word is received by the wireless transceiver, the instruction receiving module actuates the push to talk module.

12. The wireless, two-way communication device of claim 11, wherein when an end call command is received by the wireless transceiver, the instruction receiving module causes the push to talk module to terminate the communication channel with the at least one other communication device.

13. The wireless, two-way communication device of claim 11, wherein when a floor request command is received by the transceiver, the transceiver causes the push to talk module to transmit a floor request to a remote device.

14. In a wireless, two-way communication device having at least a voice recognition module and a push to talk mode, a method for establishing a push to talk communication channel comprising the steps of:
receiving an electronic actuate voice recognition module command from a wireless hands-free communication device;
actuating the voice recognition module within the wireless, two-way communication device;
receiving an electronic signal representation of an audible command comprising a push to talk code word; and
requesting a push to talk communication channel with at least one other communication device.

15. The method of claim 15, further comprising the steps of:
receiving an electronic end call command from the wireless hands-free communication device; and
terminating the push to talk communication channel.

16. The method of claim 15, further comprising the steps of:
receiving one of a toggle signal in accordance with a predetermined floor request sequence and an electronic signal representation of an audible command comprising a floor request code word; and
transmitting a floor request to a remote device.

17. A system for establishing a voice activated push to talk session, the system comprising:
a wireless hands-free device having a control button and a wireless hands-free device transceiver; and
a wireless two-way communication device having at least a wireless two-way communication device transceiver, a push to talk mode and a voice recognition module;
wherein upon the control button being actuated in accordance with a first predetermined sequence, the wireless hands-free device transceiver transmitting an actuate voice recognition software command to the two-way communication device; and
upon the wireless two-way communication device receiving the actuate voice recognition software command, the wireless two-way communication device activating the voice recognition module.

18. The system of claim 17, wherein the wireless, hands-free device comprises at least one microphone and at least one loudspeaker, wherein an audible command comprising a push to talk code word being incident upon the at least one microphone, the wireless hands-free device transceiver transmits an electronic signal representation of the audible command comprising the push to talk code word to the wireless two-way communication device.

19. The system of claim 18, wherein upon the wireless two-way communication device receiving the electronic signal representation of the audible command comprising a push to talk code word, the wireless two-way communication device transmits a push to talk data message to a remote device.

20. The system of claim 19, wherein the wireless hands-free device comprises a headset, further wherein the wireless two-way communication device comprises a mobile telephone.
